(19) United States
(12) Patent Application Publication
(10) Pub. No.: US 2016/0014688 A1
(43) Pub. Date: Jan. 14, 2016

(54) TECHNIQUES FOR MANAGING ACCESS POINT CONNECTIONS IN A MULTIPLE-PERSONA MOBILE TECHNOLOGY PLATFORM

(71) Applicant: Cellrox, Ltd., Tel Aviv (IL)

(72) Inventors: Offir GONEN, Ramat Hasharon (IL); Oren LAADAN, New York, NY (US); Amir GOLDSTEIN, Tel Aviv (IL); Micha KALFON, Tel Aviv (IL); Michael LIVSHIN, Tel Aviv (IL)

(73) Assignee: CELLROX, LTD., Tel Aviv (IL)

(21) Appl. No.: 14/797,127

(22) Filed: Jul. 11, 2015

Related U.S. Application Data
(60) Provisional application No. 62/023,183, filed on Jul. 11, 2014.

(51) Int. Cl. H04W 48/20; H04W 12/08; H04L 29/06; H04W 48/00

(52) U.S. Cl. CPC H04W 48/20; H04W 48/17; H04W 12/08; H04L 63/083; H04W 88/08

(57) ABSTRACT

A method and multiple-persona multiple technology platform (MTP) for managing connections between access points and a plurality of personas are provided. The method includes identifying at least one available access point (AP); analyzing a plurality of AP profiles defined for the plurality of personas in the MTP to identify at least one persona having permissions to connect the available access point; and establishing a connection between at least one permitted persona and the available access point respective of an AP profile of the at least one permitted persona, wherein a permitted persona is a persona in the MTP identified as having permissions to access the available access point.

### CROSS-REFERENCE TO RELATED APPLICATIONS

This application claims the benefit of U.S. Provisional Application No. 62/023,183 filed on Jul. 11, 2014, the contents of which are hereby incorporated by reference.

### TECHNICAL FIELD

The present disclosure relates generally to a multiple-persona mobile technology platform (MTP), and more specifically, to methods for connecting the MTP to a network.

### BACKGROUND

In common mobile devices, normally there are network adapters available, for example Wi-Fi® or 3rd/4th generation mobile telecommunications (3G/LTE), and one component (e.g. operating system) that makes use of them. Each mobile device is aware of access points (APs) available in the proximity, and may choose to connect to a network through a network adapter by using one of the available APs. When there are multiple matching APs available, an algorithm/policy is executed to decide which AP to connect to.

In multiple-persona mobile technology platforms (MTPs), there are typically multiple components (e.g. personas) that are able to make use of a single AP. Such personas may or may not be aware of the APs available in the proximity of the mobile device. The problem is the personas are independent of each other, and therefore are not always aware when another persona is trying to connect to the AP. Therefore using an AP is typically not sufficient to satisfy the needs of all personas, the user of the MTP, and the admin policy of the MTP.

As an example, when there are multiple APs available, decisions must be taken regarding, for example, how to inform the MTP that multiple APs are available, which AP to connect to, which persona of the MTP to perform the connection, and so on. Therefore, there is a need to manage the establishment of AP connections by the MTP.

Another problem may arise when providing permissions to use an AP connection reachable by the MTP. The use of the AP connection must be adjusted to the MTP and to the usage of the multiple personas respective thereof. In addition, there is a need to ensure that the access to the AP connection is appropriately made. As an example, when connecting to a remote site through a preferred AP, a user may be required, when using a business persona, to connect to remote sites to access the Internet only via a corporate Wi-Fi network. In addition, in such a case, only the business persona should be authorized to access the corporate Wi-Fi network.

Another problem may arise when switching between one persona to another persona and each persona independently takes and carries out its own decisions about connections. Further, in such configurations connections' states should be synchronized between personas.

In certain configurations personas utilize a shared logic that is responsible for AP connections. In such a configuration, two or more personas may have conflicting demands with respect to requested connections.

It would therefore be advantageous to provide an efficient solution for managing access point connections in a MTP.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Some embodiments of the disclosure relate to a method for managing connections between access points and a plurality of personas in a multiple-persona mobile technology platform (MTP). The method comprises: identifying at least one available access point (AP); analyzing a plurality of AP profiles defined for the plurality of personas in the MTP to identify at least one persona having permissions to connect the available access point; and establishing a connection between at least one permitted persona and the available access point respective of an AP profile of the at least one permitted persona, wherein a permitted persona is a persona in the MTP identified as having permissions to access the available access point.

Some embodiments of the disclosure relate to a multiple-persona mobile technology platform (MTP) for managing connections between access points and a plurality of personas in the MTP. The MTP comprises: a processing unit; and a memory, the memory containing instructions that, when executed by the processing unit, configure the MTP to: identify at least one available access point (AP); analyze a plurality of AP profiles defined for the plurality of personas in the MTP to identify at least one persona having permissions to connect the available access point; and establish a connection between at least one permitted persona and the available access point respective of an AP profile of the at least one permitted persona, wherein a permitted persona is a persona in the MTP identified as having permissions to access the available access point.

### BRIEF DESCRIPTION OF THE DRAWINGS

The subject matter that is regarded as the disclosed embodiments is particularly pointed out and distinctly claimed in the claims at the conclusion of the specification. The foregoing and other objects, features and advantages of the disclosed embodiments will be apparent from the following detailed description taken in conjunction with the accompanying drawings.

FIG. 1 is a schematic block diagram of a networked system utilized to describe the various disclosed embodiments.

FIG. 2 is a flowchart describing a method for establishing a connection to an access point (AP) by a MTP according to an embodiment.

FIG. 3 is a flowchart describing a method for granting access to the established AP connection according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

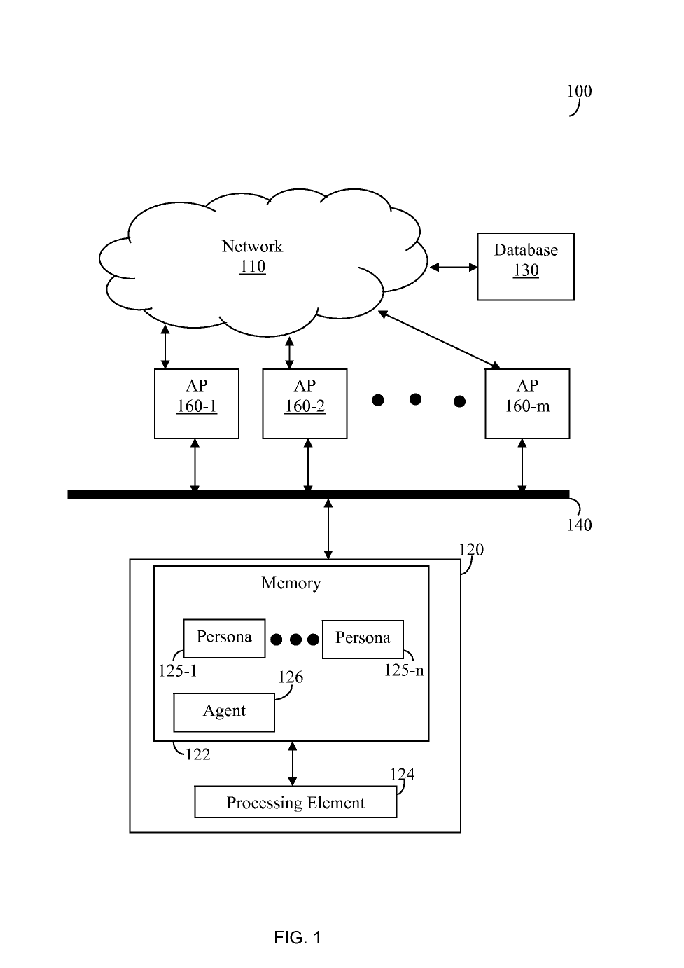

FIG. 1 is an exemplary and non-limiting schematic diagram of a system 100 utilized to describe the various embodiments disclosed herein. The system 100 includes a network 110, a multiple-persona mobile technology platform (MTP) 120 communicatively connected to the network 110 and access points (AP) 160-1 through 160-m allowing connection to the network 110. The network 110 may be a virtual network, a local area network (LAN), a wireless LAN (e.g., Wi-Fi or WiGig networks), a cellular network, a system area network (SAN), a wide area network (WAN), a metro area network (MAN), the worldwide web (WWW), the Internet, implemented as wired and/or wireless networks, and any combinations thereof.

A communication of the MTP 120 with an AP 160 is established through a medium 140 which may be a wireless or wired medium. An AP 160 reachable by the MTP 120 may be any physical or logical element enabling the MTP 120 to communicatively connect to the network 110 by using, for example, but without limitation, Wi-Fi®, WiGig® 3rd/4th generation mobile telecommunications (3G/LTE), Bluetooth®, a networked cable, a virtual private network (VPN) connection, point-to-point protocol (PPP) connection, or other communication related standards. The APs 160 may be available, for example, at beverage and/or snack vendors, hotels, mass transit, and other retail and/or service vendors that offer such access, as well as at work places or at home. The APs 160 may be located in the same location and/or different locations (e.g., AP 160-1 is of a home Wi-Fi network while 160-2 is of a business Wi-Fi network). In certain configurations, two or more APs 160 may serve the same network.

The MTP 120 is a computing device including a processing unit 122 and memory 124. The MTP 120 may be, but is not limited to, a tablet computer, a laptop computer, a smartphone, a cellular phone, a notebook computer, an intra-vehicle infotainment system (IVI), a wearable computing device, and the like. In an embodiment, each MTP 120 is configured with a plurality of personas, for example, persona 125-1 through persona 125-n (n is an integer greater than 1). A persona refers to at least one role or identity associated with and assumable by a user of the MTP 120. The roles or identities of the user correspond to a unique execution environment. The execution environment may be a virtual execution environment, an operating system, a sandbox, a userspace container, a hypervisor, or any combination thereof. Each persona 125 is associated with a unique set of metadata.

In an embodiment, a persona is a user profile defined as part of an operating system supporting a multiple-user feature in the MTP 120. Such a user profile is maintained and monitored by the MTP's 120 operating system and allows the user to define under each profile a set of specific applications (apps), passwords, and other lock mechanisms associated with a specific user of the profile. For example, one user profile may be set for the owner of the MTP 120 where all applications are available and another profile for a child using the MTP 120 where only games may be available.

In certain configurations, the MTP 120 further includes an agent 126 installed therein. The agent 126 may be executable code that is associated with the memory 124 and executed by the processing unit 122. Alternatively to the agent 126, a service that is supported by an operating system (OS) of the MTP 120 may be used. The various embodiments for managing AP connections for the personas 125 are performed under the control of the agent 126. In further certain configurations, the agent 126 may be any service running outside of a persona or in a persona.

The memory 124 of the MTP 120 further includes instructions, settings, rules, and configurations associated with persona 125. As will be discussed below, the memory 124 may further include for each persona 125 an AP policy defining permissions and other settings for the AP 160.

The processing unit 122 is communicatively connected to the memory 124. The processing unit 122 is configured to execute, among others, the instructions of the agent 126 and any of the instructions for enabling the operation of the personas 125, and the processes for managing content items accessible by the personas 125 according to an embodiment.

The processing unit 122 may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

In an embodiment, the memory 124 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code).

As noted above, the memory 124 includes for each persona a profile for accessing APs 160 (hereinafter the AP profile). In a non-limiting and exemplary embodiment, the AP profile includes a provision type for connecting to a particular AP 160. For example, a provision type includes an automatic connection to an AP 160 with respect to all the personas 125 or particular personas 125, connection to an AP 160 upon identification of an environmental parameter, request for a permission to connect to an AP 160 (e.g., whether persona(s) 125 owning a connection can share the connection and/or its credentials with other personas 125), prioritized connection priorities for a persona 125 over another when establishing the connection (e.g., in a case of traffic overload, a specific persona 125 is not permitted to connect and/or to access a particular AP 160), and the like. Non limiting examples for an environmental parameter may include a location of the MTP 120, a time information at the location of the MTP 120, a temperature respective location, proximity of the MTP 120 to one or more objects, level of environmental light, level of environmental sound), and so on.

An AP profile of a persona 125 may also define if the persona 125 can share an AP connection with another persona 125 or whether the AP 160 can be used exclusively by the persona 125. Sharing of the AP 160 may include sharing credentials and other properties of the AP connection.

The AP profile may also include an AP type that a persona 125 can connect to. The AP type may be a secured AP connection (e.g., a Wi-Fi connection requires a password), a public (secured) AP connection, type of network to connect to (e.g., Wi-Fi, cellular network, wired network, and the like), and so on. For example, a personal persona may allow connection to a public AP 160, while a business persona will not.

In an embodiment, the AP profile of each persona 125 can be updated upon successful connection to an AP 160. The profile may be updated with a password for establishing the connection, various keys exchanged during the handshake process, properties of the connection, and so on.

In an embodiment, AP profiles of the personas 125 may be defined by information technology (IT) personnel, a security policy, a server external to the MTP 120, a user of the MTP 120, and the like, or combination thereof.

In another embodiment, the AP profiles defined for all personas 125 may be also saved in a database 130. In an embodiment, AP profiles can be shared among personas 125. The database 130 is connected to the MTP 120 as an external component via the network 110.

According to the various disclosed embodiments, the management of AP connections to personas 125 is performed by the agent 126. The management of the AP connections to personas 125 is performed with respect to the AP profile defined for each persona 125.

In the embodiment, the agent 126 is configured to scan all available APs 160 and attempt to establish a connection with at least one AP 160 based at least on the connection provision and AP type defined in the AP profile associated with the second persona. For example, if the AP type is a specific AP 160 (e.g., a specific SSID “my-network”) and the connection provision requires satisfying an environmental parameter defining a time of the day (e.g., 9 AM to 5 PM), then the agent 126 will check if these conditions are met prior to establishing a connection. As a non-limiting example, a persona 125 may be permitted to connect to the AP 160 respective of previous use of the AP 160. However, in order to establish the connection to the AP 160, the environmental parameters associated with such persona 125 must occur. As another example, but not by way of limitation, such environmental parameters may be: performing the connection to the AP 160 only in the morning within the office area. Information respective of the personas 125 which previously accessed the AP 160 and/or information respective of the environmental conditions may be retrieved from the database 130.

In a certain embodiment, the agent 126 further checks if a connection was previously established with the one of APs 160 detected scan. The connection may be previously established by a persona currently requesting a connection or a different persona. For the former case, the agent 126 can establish the connection using credentials already stored in the respective AP profile. For the latter case, it is checked if the connection's credentials are shared with the requesting persona, and if so the connection can be established.

In an embodiment, when the agent 126 establishes a connection with an AP 160 for the first time, the AP's credentials and properties are saved in the AP profile of the respective persona (e.g., the second persona).

Upon establishing a connection of the MTP 120 with an AP 160, the agent 126 is further configured to determine if an access to the connection should be granted to other personas 125 in the MTP 120. In an embodiment, the agent 126 is configured to notify the other personas that a connection is established, thereby allowing each persona to request an access grant. In an alternative embodiment, the agent 126 provide an access grant to other persona(s) 125. The determination whether or not to allow such a request is based on the AP profile of the requesting persona and/or AP profile of the persona 125 initiated or owning the connection. In certain embodiments, the agent 126 is configured with a list of personas 125 that should grant an access to an established connection.

It should be noted that the various embodiments have been described as requiring “establish a connection with an AP” and “grant an access to an AP”, merely for the sake of simplicity of the description. It should be appreciated that there are two separate entities for a connection: a hardware element (e.g., a network adapter) of the MTP 120 and personas.

It should be appreciated that an “establish a connection” is an action that connects the MTP's 120 network adapter to an AP 160. An established connection is not visible (or available) to any persona. To make a connection available to a persona, an access to the established connection is granted to the persona.

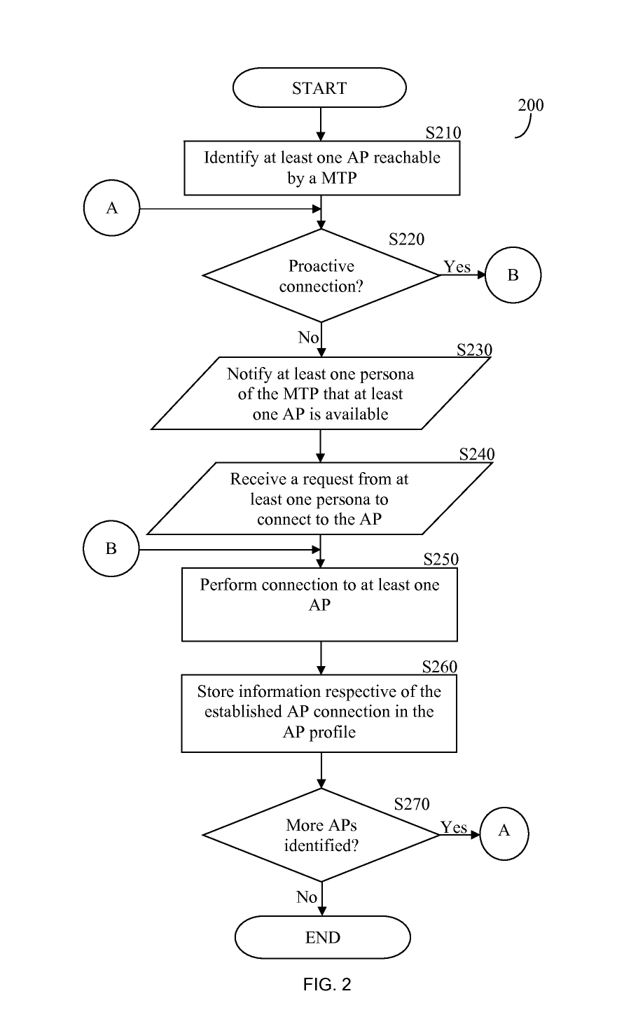

FIG. 2 depicts an exemplary and non-limiting flowchart 200 describing a method for establishing a connection to an AP for a persona of the MTP 120 according to an embodiment. In S210, at least one available AP is identified. The identification may be performed through a roaming processing, or any network discovery process known in the art.

Upon identification of an available AP, in S220, it is checked whether to perform a proactive connection; and if so execution continues with S250; otherwise, execution continues with S230. A proactive connection is a connection to the identified AP without receiving any additional instruction from the persona. The determination is made based on the settings defined in the AP profile of the persona. If a proactive connection is permitted, then the connection with the AP is automatically established or upon satisfying at least one environmental parameter. As noted above, such a parameter may include, e.g., a location of the MTP 120, time information at the location of the MTP 120, temperature respective location, proximity of the MTP 120 to one or more objects, level of environmental light, level of environmental sound), and the like.

As a non-limiting example, the proactive connection may be performed upon identification of particular environmental conditions that satisfy the environmental parameters respective of a particular persona. In this case, the environmental conditions are analyzed to determine whether the environmental parameters required for connecting such persona to the AP are held to enable the connection.

In S230, at least one persona of the MTP 120 is notified about the availability of the AP. The decision of which persona should be notified is made based on an AP profile defined for each persona. According to an embodiment, the notification is displayed to the user of the MTP 120, for example, via the interface of a persona running in the foreground, informing the user of the available AP(s). According to another embodiment, the notification is displayed via the interface of the personas configured to receive such notifications. In S240, at least one request to connect to at least one AP is received from at least one permitted persona. According to an embodiment, the agent 126 is configured to give permissions for at least one permitted persona to establish a connection to the AP.

In S250, at least one connection to at least one AP is performed. When performing the connection, a request to connect to the AP is sent to the AP. It should be noted that a password may be provided, typically by the user of the MTP 120, if such password is requested by the AP.

It should be noted that only the permitted personas are granted an access to an available AP. As an example, a personal persona may not have permissions to connect to an AP belonging to a government office. According to another embodiment, in the case of the reactive connection, the connection to the AP may be performed in an order of which the requests were received from the personas. According to yet another embodiment, the connection to the AP may be performed with respect to the foreground persona. According to yet another embodiment, the connection to the AP may be determined to be shared or exclusive as further described below.

It should be noted that a persona can actively refuse to exercise a grant to access the available AP. As an example, a business persona may prefer not be connected to Wi-Fi® for security reasons. Additionally, a persona may be prioritized over another when granting an access for example, in a case of traffic overload. This prioritization is performed based on the information stored in the AP profile. In some embodiments, the access is granted through enforcing communication parameters, such as a protocol type, firewall rules, bandwidth, and the like.

In S260, information respective of the connection performed is stored in the AP profile of the permitted persona (i.e., the persona that the connection is established with). The connection information may include credentials to connect to the AP, properties of the AP connections, environmental parameters required for connecting to the AP, and so on. In an embodiment, such information further defines if the AP connection is a shared or exclusive connection.

According to an exemplary embodiment, the properties of the AP connection may include the details of the permitted persona to perform the connection to the AP. According to this example, the permitted persona requesting to connect to the AP is configured to determine that the connection to such AP will be exclusive only to such persona. Such determination may be performed respective of the AP profile defined for the permitted persona. It should be noted that a persona having an exclusive connection to an AP is configured to provide permissions to other personas to grant an access to such AP, and therefore to create a shared AP connection. Such permissions may be stored in AP profiles of each persona that can use the connection or in a global profile maintained by the agent 126.

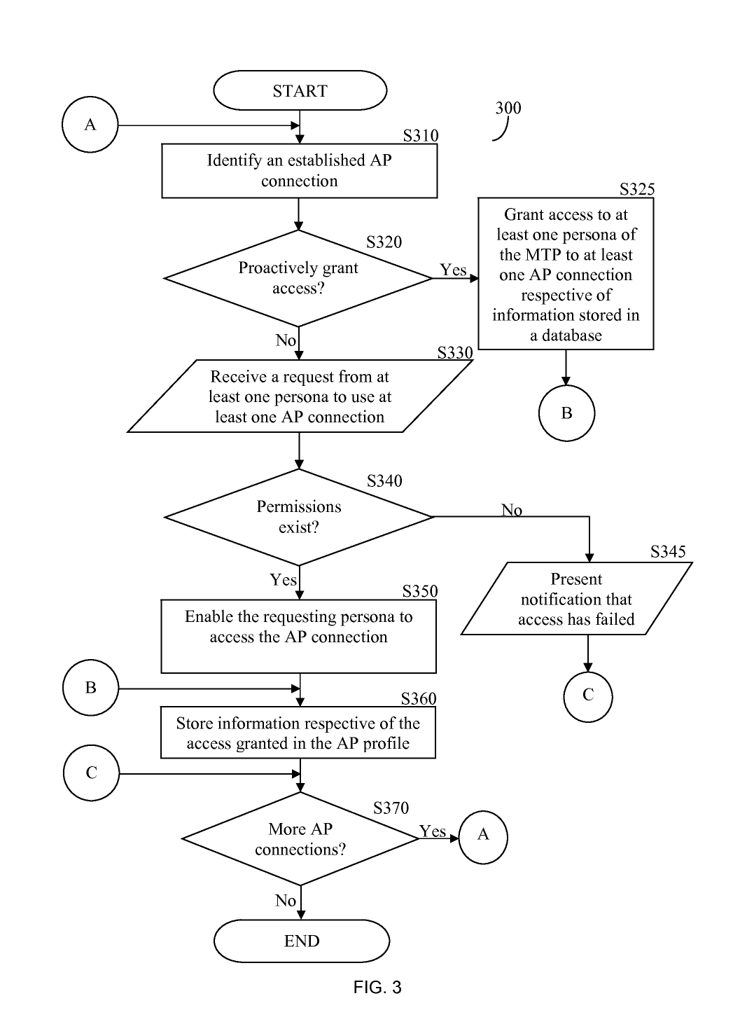

According to another example, the properties of a shared AP connection may include permissions to use the connection, the password required by the AP and so on. According to yet another embodiment, the properties of the AP connection may include the details of one or more personas that own the AP connection. For example, an owner can be the persona that requested the connection initially, one or more personas having permissions to access the AP connection, one or more personas having the credentials to an established connection, and so on. In such case, when a disconnection from an AP is required, only the persona that owns the AP connection will be configured to stop the AP connection. This action may affect other personas having permission to use the AP connection. The access granting is described further herein below with respect to FIG. 3.

A notification may be displayed to the user on a display of the MTP 120 respective of a connection established between a persona and the AP. Alternatively, a notification may be displayed on the interface of such persona, offering to use the AP, rather than performing an automatic connection. It should be understood that additional notifications may be displayed to the user (e.g., on the interface of a particular persona or the foreground persona) offering, for example, to grant access to an AP connection, share the AP connection, create an exclusive AP connection, connect to other available APs, and the like.

In S270, it is checked whether additional APs are identified, and if so execution continues with S220; otherwise, execution terminates. Notifications respective of the network situation can be displayed to the user on the interface of a particular persona. In an embodiment, the particular persona is a foreground persona. Such notifications are used to indicate, for example, a persona is connected to the AP, the persona is not connected to the AP, the persona is not connected to the AP but other personas are connected, the persona is connected to 3G and other personas are connected via Wi-Fi®, a VPN connection is offered to be shared by another persona, and the like. It should be understood each one of the notifications is displayed respective of the AP profile defined for each persona.

FIG. 3 depicts an exemplary and non-limiting flowchart 300 describing a method for granting access to an AP connection established by the MTP according to one embodiment. A plurality of APs may be connectable by the MTP 120 and one or more personas 125 may be permitted to access different types of AP connections. The permission to access different types of AP connections may be granted by the agent 126. The decision of which AP 160 to connect to and by which persona 125 is made based on, for example, user inputs/configuration and respective AP profiles and/or the policy of the OS of the MTP 120.

In S310, at least one established AP 160 connection is identified. In S320, it is checked whether to proactively grant an access to the AP connection to personas 125 not currently connected. If so execution continues with S325; otherwise, execution continues with S330. In an embodiment, S320 includes analyzing the AP profiles defined for the personas 125.

In S325, the access to the AP 160 connection is granted to at least one persona 125 identified in S320, then execution continues with S360. The decision of which persona to grant the access is performed respective of the AP profiles defined for the personas.

According to an embodiment, only personas permitted to connect to the AP 160 will be granted with the access. According to another embodiment, the access to the AP 160 may be granted with respect to the persona 125 running in the foreground. According to yet another embodiment, the access to the AP 160 may be determined to be shared or exclusive as further described below.

In S330, at least one request to use the AP 160 connection is received from at least one persona 125. In S340, it is checked whether the requesting persona 125 has permissions to access the AP 160, and if so execution continues with S350; otherwise, execution continues with S345. The check in S340 includes analyzing information defined in the AP profile of the requesting persona. Such information includes, for example, the AP 160 connections that were previously used by the persona 125 and/or if the connection was previously shared with the requesting persona. In S345, a notification is presented to the requesting persona 125 notifying that the attempt to access the AP 160 connection has failed and thereafter execution continues with S370.

In S350, the requesting persona is enabled to access the AP connection. According to an embodiment, the persona may be identified as permitted to access to the AP connection respective of previous use of the AP connection. According to another embodiment, the nature of the persona and its eligibility to be exposed to the AP connection is determined respective of the unique set of rules associated with the persona. According to yet another embodiment, a persona determined to be permitted to access the AP connection may be configured to perform the access setup by itself. The determination is performed with respect to, for example, the policy of the OS of the MTP 120, user inputs, the AP profile defined for the persona, and the like. In case the AP connection is owned by one persona, such as the persona 125-n, it is checked whether such persona 125-n permits the requesting persona (e.g., persona 125-1) to access the AP.

In S360, information (e.g., properties) respective of the requesting persona 125 permitted to access the AP 160 connection is stored in its AP profile. A notification may be displayed to the user of the MTP 120 respective thereof. According to an embodiment, a notification is displayed on the interface of the requesting persona, offering to use the AP, rather than performing an automatic connection.

In S370, it is checked whether there are additional accessible AP connections identified, and if so execution continues with S310; otherwise, execution terminates. It should be noted that a persona 125 having an access to an AP 160 connection is configured to stop the access, for example, in response to a change in policy or a change in the connection properties. Such access can be also stopped by the agent 126 when required.

As a non-limiting example, a new AP connection is identified by the agent 126 and the personas of the MTP are notified respective thereof. The agent 126 receives a request from a persona 125-1, found in foreground of the MTP 120, to establish the AP 160 connection. In addition, the persona 125-1 requests that the connection to the AP 160 be performed automatically and that the AP 160 connection will be defined as a shared connection. Such information is stored in the database 130 for further use with respect to the persona 125-1. Later, when a request is received by the persona 125-1 to connect to AP 160, the connection is performed according to the information retrieved from the database 130. The access to the AP 160 connection is granted by the agent 126 respective thereof. It should be understood that because the AP 160 connection is defined as shared, access to such AP 160 connection can be granted to other personas 125 of the MTP 120, for example, persona 125-n. It should be noted that the connection to the AP 160 and the access to the connection is granted to the personas 125-1 and 125-n each time the AP 160 connection is available to the MTP 120 regardless of the current foreground persona 125.

According to another non-limiting example, a new secure AP 160 connection is identified by the agent 126 and the personas 125 of the MTP 120 are notified respective thereof. The agent 126 is configured to receive a request from a persona 125-1, found in foreground of the MTP 120, to establish the AP connection. In addition, the persona 125-1 requests that the connection to the AP will be performed automatically and that such AP connection will be defined as an exclusive connection. Such information is stored in the AP profile for further use with respect to the persona 125-1. Later, when a request is received by personas 125-1 and 125-n to connect to the AP, the connection is performed according to the information retrieved from the respective AP profile. In this example, the persona 125-1 is connected to the secure AP connection upon providing required credentials, while the persona 125-n is connected to alternative AP connections (as further described below) regardless of a persona 125 currently running in the foreground.

According to an embodiment, when no permissions were identified for accessing an AP connection by at least one persona, for example, persona 125-n, the persona 125-n is configured to use other means to connect to the network. The connection may be performed automatically, or respective of inputs received by the MTP 120. As an example, in case the MTP 120 is configured to connect to multiple APs 160 concurrently, at least one virtual communication channel, for example, a VPN connection, is assigned with respect to the persona 125-n. The connection can be shared with other personas 125 respective of information related to each persona 125. As another example, in case the MTP 120 is configured with a data connection, such as, 3G, the persona 125-n may use the data connection. It should be noted that the virtual communication channel can be also created on top of an established, granted AP 160 connection in the personas 125.

The various disclosed embodiments are implemented as hardware, firmware, software, or any combination thereof. Moreover, the software may be implemented as an application program tangibly embodied on a program storage unit or non-transitory computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for managing connections between access points and a plurality of personas in a multiple-persona mobile technology platform (MTP), comprising:
identifying at least one available access point (AP);
analyzing a plurality of AP profiles defined for the plurality of personas in the MTP to identify at least one persona having permissions to connect the available access point; and
establishing a connection between at least one permitted persona and the available access point respective of an AP profile of the at least one permitted persona, wherein a permitted persona is a persona in the MTP identified as having permissions to access the available access point.

2. The method of claim 1, wherein establishing the connection between at least one permitted persona and the available access point further comprises:
establishing the connection between a network element of the MTP and the available access point; and
granting to the at least one permitted persona an access to the available access point.

3. The method of claim 1, further comprising:
notifying the at least one permitted persona about the available access point; and
establishing the connection between the at least one permitted persona and the available access point, upon receiving a request from the at least one permitted persona.

4. The method of claim 1, wherein each persona of the plurality of personas in the MTP is a user profile defined as part of an operating system supporting a multiple-user feature of the MTP.

5. The method of claim 1, wherein the AP profile comprises at least one of: a connection provision, allowable access points, learnt credentials of access points, and properties of the previously connected access points.

6. The method of claim 5, wherein the properties of an access point are provided by the at least one permitted persona upon establishing the connection with the access point, wherein the properties include at least one of: permissions to use the access point connection, a password required by the access point, and a type of the access point.

7. The method of claim 1, further comprising:
displaying a notification to the at least one permitted persona offering to connect to the access point.

8. The method of claim 1, further comprising:
displaying at least one notification to one or more personas of the MTP indicating the network status.

9. The method of claim 1, wherein the connection is established respective of a priority assigned to personas requesting to connect to the available access point.

10. The method of claim 1, wherein establishing the connection between the at least one permitted persona and the available access point further comprises:
configuring the at least one permitted persona to establish a connection to the available access point.

11. The method of claim 1, further comprising:
granting an access to the available access point to at least one persona other than the at least one permitted persona, upon establishing the connection between the at least one permitted persona and the access point.

12. The method of claim 11, further comprising:
proactively granting the access to personas not currently connected but having permissions to access the available access point.

13. The method of claim 12, wherein a persona is determined to have permissions to access the available access point based on the AP profile defined for the persona.

14. The method of claim 11, wherein the access is granted upon receiving a request from at least one persona other than the permitted persona.

15. The method of claim 14, further comprising:
notifying the at least one persona that the attempt to access the available access point has failed, upon identifying that the at least one persona is not permitted to access the available access point; and
configuring the at least one persona to access the available access point, upon identifying that the at least one persona is permitted to access the available access point.

16. The method of claim 12, further comprising:
displaying a notification to the MTP informing which personas of the plurality of personas have access to the available access point.

17. The method of claim 12, wherein the available access point is configured to provide a network access through at least one of: a physical communication channel and a virtual communication channel.

18. The method of claim 17, wherein the virtual communication channel includes any one of: a virtual private network (VPN) connection and point-to-point protocol (PPP) connection.

19. The method of claim 18, wherein the physical communication channel includes at least any one of: Wi-Fi®, WiGig®, 3rd/4th generation mobile telecommunications (3G/LTE), Bluetooth®, and a network cable.

20. A non-transitory computer readable medium containing instructions that when executed on a computing device performs the method of claim 1.

21. A multiple-persona mobile technology platform (MTP) for managing connections between access points and a plurality of personas in the MTP, comprising:
a processing unit; and
a memory, the memory containing instructions that, when executed by the processing unit, configure the MTP to:
identify at least one available access point (AP);
analyze a plurality of AP profiles defined for the plurality of personas in the MTP to identify at least one persona having permissions to connect the available access point; and
establish a connection between at least one permitted persona and the available access point respective of an AP profile of the at least one permitted persona, wherein a permitted persona is a persona in the MTP identified as having permissions to access the available access point.

22. The MTP of claim 21, wherein the MTP is any one of: a cellular phone, a smartphone, a tablet device, a notebook computer, a laptop, an in-vehicle infotainment system (IVI) a personal computer (PC), and a wearable computing device.

23. The MTP of claim 21, wherein the MTP is further configured to:
establish the connection between a network element of the MTP and the available access point; and
grant to the at least one permitted persona an access to the available access point.

24. The MTP of claim 21, wherein the MTP is further configured to:
notify the at least one permitted persona about the available access point; and
establish the connection between the at least one permitted persona and the available access point, upon receiving a request from the at least one permitted persona.

25. The MTP of claim 21, wherein each persona of the plurality of personas in the MTP is a user profile defined as part of an operating system supporting a multiple-user feature of the MTP.

26. The MTP of claim 21, wherein the AP profile comprises at least one of: a connection provision, allowable access points, learnt credentials of access points, and properties of the previously connected access points.

27. The MTP of claim 26, wherein the properties of an access point are provided by the at least one permitted persona upon establishing the connection with the access point, wherein the properties include at least one of: permissions to use the access point connection, a password required by the access point, and a type of the access point.

28. The MTP of claim 21, wherein the MTP is further configured to:
display a notification to the at least one permitted persona offering to connect to the access point.

29. The MTP of claim 21, wherein the MTP is further configured to:
display at least one notification to all personas of the MTP indicating the network status.

30. The MTP of claim 21, wherein the connection is established respective of a priority assigned to personas requesting to connect to the available access point.

31. The MTP of claim 21, wherein the MTP is further configured to:
configure the at least one permitted persona to establish a connection to the available access point.

32. The MTP of claim 21, wherein the MTP is further configured to:
grant an access to the available access point to at least one persona other than the at least one permitted persona, upon establishing the connection between the at least one permitted persona and the access point.

33. The MTP of claim 32, wherein the MTP is further configured to:
proactively grant the access to personas not currently connected but having permissions to access the available access point.

34. The MTP of claim 33, wherein a persona is determined to have permissions to access the available access point based on the AP profile defined for the persona.

35. The MTP of claim 32, wherein the access is granted upon receiving a request from at least one persona other than the permitted persona.

36. The MTP of claim 35, wherein the MTP is further configured to:
notify the at least one persona that the attempt to access the available access point has failed, upon identifying that the at least one persona is not permitted to access the available access point; and
configure the at least one persona to access the available access point, upon identifying that the at least one persona is permitted to access the available access point.

37. The MTP of claim 33, wherein the MTP is further configured to:
display a notification to the MTP informing which personas of the plurality of personas have access to the available access point.

38. The MTP of claim 33, wherein the available access point is configured to provide a network access through at least one of: a physical communication channel and a virtual communication channel.

39. The MTP of claim 38, wherein the virtual communication channel includes any one of: a virtual private network (VPN) connection and point-to-point protocol (PPP) connection.

40. The method of claim 39, wherein the physical communication channel includes at least any one of: Wi-Fi®, WiGig®, 3rd/4th generation mobile telecommunications (3G/LTE), Bluetooth®, and a network cable.
